(19) United States
(12) Patent Application Publication
(10) Pub. No.: US 2011/0159171 A1
(43) Pub. Date: Jun. 30, 2011

(54) Method for preparing organic light emitting diode and device thereof

(75) Inventors: Chain-Shu Hsu, Hsinchu (TW); Hsin-Fei Meng, Hsinchu (TW); Sheng-Fu Horng, Hsinchu (TW); Hsiao-Wen Zan, Hsinchu (TW); Hsin-Rong Tseng, Hsinchu (TW); Chung-Ling Yeh, Hsinchu (TW); Hung-Wei Hsu, Hsinchu (TW); Chang-Yao Liu, Hsinchu (TW); Hsiu-Yuan Yang, Hsinchu (TW)

(73) Assignee: National Chiao Tung University, Hsinchu (TW)

(21) Appl. No.: 12/803,329

(22) Filed: Jun. 23, 2010

(30) Foreign Application Priority Data
Dec. 28, 2009 (TW) 98145248

(51) Int. Cl. B05D 5/06; B05C 9/14

(52) U.S. Cl. 427/66; 118/58

(57) ABSTRACT

A method for fabricating an organic light emitting diode and a device thereof are provided. The method includes: providing a substrate; dispensing to the substrate a second organic molecule solution resulting from dissolving a second organic molecule in a solvent; applying the second organic molecule solution to a surface of the substrate so as to form a wet film layer; and heating the wet film layer by a heating unit to remove the solvent therefrom and thereby form a second organic molecule film. The method is effective in fabricating a uniform multilayer structure for use in fabrication of large-area photoelectric components.

### BACKGROUND OF THE INVENTION

1. Field of the Invention

The present invention relates to a method and device for fabricating organic light emitting diodes, and more particularly, to a method and device for fabricating, by blade coating, an organic light emitting diode which has a multilayer structure and/or is patterned.

2. Description of the Prior Art

In general, an organic light emitting diode is fabricated by disposing on a glass substrate an anode formed by a layer of transparent conductive material made of, for example, tin-doped indium oxide (ITO), disposing on the anode a hole feeding layer, a hole conveying layer, an organic light emitting layer, an electron conveying layer, and an aluminum cathode in sequence, and applying a voltage to between the anode and the cathode, so as for the organic light emitting diode thus fabricated to emit light.

Organic light emitting diodes are fabricated mostly by evaporation. For example, the fabrication process involves placing a transparent ITO substrate in a vacuum gas deposition device and performing an evaporation procedure on layers of material in sequence by vacuum vaporization until each of the layers of material is transferred to the substrate to form a multilayer structure. In this regard, the aforesaid evaporation technique is applicable to organic light emitting diodes with a small-molecule organic material layer and fabrication of a multilayer structure. However, the aforesaid evaporation technique incurs high costs and requires complicated operation and therefore is inapplicable to fabrication of large-area components or devices.

Alternatively, organic light emitting diodes are fabricated by spin coating as disclosed in Taiwan Patent No. 200627666 and U.S. Pat. No. 6,964,592. Spin coating is essentially applicable to fabrication of organic light emitting diodes with a large-molecule organic material layer. However, spin coating has a drawback, that is, during a process of fabricating a multilayer structure by spin coating, severe miscibility between the layers of the multilayer structure renders the fabrication process unstable and prevents the product from meeting industrial demand.

Methods for reducing interlayer miscibility are proposed in the prior art as follows: Muller, C. David et al., 2003, Nature 421, 829-833; Huang et al., 2002, Advanced Materials, Vol. 14, pp. 565-569; and Yan et al., 2004, Advanced Materials, Vol. 16, pp. 1948-1953. The aforesaid proposals involve: altering the solubility of the light emitting material by modifying an organic molecule material (for example, metal-doping an organic molecule material);

applying the modified organic molecule material to a glass substrate by coating; aggregating the material by heating treatment and UV radiation so as to prevent the material from being dissolved by a subsequent material layer; repeating the above steps to attain a multilayer component; and fabricating a multilayer photoelectric component by evaporation and packaging. However, the aforesaid proposals are aimed at chemical materials and thus confronted with limitations, inflexibility, and narrow scope of application when applied to organic molecule structure design.

Hence, there is still room for improving the convention method for fabricating large-area organic light emitting diodes.

The application of patterned products is wide and includes signboards, billboards, and products, for example. Hence, patterning a light emitting diode can further widen the application of the light emitting diode. If patterned products are fabricated by a fabrication process that involves using inorganic light emitting diode, the light emitting diodes must be presented in the form of point light sources and arranged in an array, and in consequence the fabrication process will be intricate and will disadvantageously result in unevenness of light color.

However, it is a new idea to pattern organic light emitting diodes. Journal of Vacuum Science and Technology (2008), Vol. 26, pp. 2385-2389 discloses using a Cr layer as a mask for use in an etching process for fabricating a Si mold, creating a mold on the Si mold, and then imprinting a film of the Si mold on a substrate so as to achieve the effect of patterning. Also, Current Applied Physics (2006), Vol. 6, pp. 627-631 discloses fabricating a small-dimensions patterned light emitting layer by a capillary and a polydimethylsiloxane mold panel, wherein a solution flows due to the difference in pressure between two ends of the capillary, and film properties depend on viscosity of the solution. The methods disclosed in the aforesaid literature are intricate, and the conditions for the fabrication process performed by the method are difficult to control, not to mention that the methods disadvantageously feature instability, low success rates of patterning, failure to fabricate patterns of any shapes, and low industrial applicability.

Accordingly, it is imperative to provide a method and device for fabricating large-dimension organic light emitting diodes and preventing interlayer miscibility.

### SUMMARY OF THE INVENTION

The present invention provides a method for fabricating an organic light emitting diode, comprising steps of: (a) providing a substrate; (b) dispensing to the substrate a second organic molecule solution resulting from dissolving a second organic molecule in a solvent; (c) applying the second organic molecule solution to a surface of the substrate so as to form a wet film layer; and (d) heating the wet film layer to remove the solvent therefrom and thereby form a second organic molecule film.

In a specific embodiment, the method of the present invention further comprises spinning the wet film layer after the wet film layer is formed by a blade, because spinning prevents wavy grain from being formed on the wet film layer applied by the blade. After the spinning of the wet film layer, the wet film layer is heated to remove a solvent therefrom so as to form a second organic molecule film. According to the present invention, the blade used in the step of blade coating is a conventional planar blade. For example, a conventional square-shaped blade has a planar edge such that the planar area faces the surface of the substrate. Alternatively, the edge of the blade is linear. In this application document, the term “edge” means a specific portion of the blade such that the specific portion is proximal to the substrate and is configured to move an organic molecule solution.

The spinning speed depends on the organic molecule solution used. In general, the spinning speed ranges between 100 rpm and 8000 rpm, preferably between 100 rpm and 5000 rpm, and most preferably between 800 rpm and 2000 rpm.

The spinning step is usually performed immediately after the step of forming a wet film layer by blade coating. In a specific embodiment, the substrate is spun within 10 seconds, or preferably within 5 seconds, after the wet film layer is formed.

In a specific embodiment, the wet film layer is heated up within 20 seconds after the spinning step has begun. In a preferred embodiment, the wet film layer is heated up within 5 seconds after the spinning step has begun, regardless of whether the substrate is spun. The heating step is performed by a heating unit configured to effectuate a target temperature of between 40° C. and 800° C. In a preferred embodiment, the target temperature is between 40° C. and 200° C.

To obtain the multilayer structure, a first organic molecule film is formed on the substrate first, and then a second organic molecule solution is applied to the first organic molecule film on the substrate so as to form a second organic molecule film. In so doing, interlayer miscibility is prevented.

To be specific, fabricating an organic light emitting diode with a multilayer structure according to the present invention essentially involves repeating the steps of dispensing the organic molecule solution, blade coating, and heating, in sequence. In so doing, it is feasible to form an organic light emitting diode with a multilayer structure. The method of the present invention is effective in effectuating the desirable number of layers of an organic light emitting diode and spreading the multilayer structure evenly using a whole-solution process, and is applicable to fabrication of a large-area photoelectric component.

In another embodiment, the method of the present invention further comprises covering the substrate with a patterned mask before dispensing the second organic molecule solution, so as to form a patterned second organic molecule film.

In yet another embodiment, the first organic molecule film is formed from a patterned film formed by a patterned mask, so as to obtain a patterned organic light emitting diode.

In an embodiment that involves using a patterned mask, the patterned mask comprises a patterned soft plastic film. To be specific, the patterned mask comprises a hard layer and a soft plastic film formed on the hard layer. To obtain a patterned organic molecule film, such as the aforesaid first organic molecule film, the patterned mask must have a through hole that penetrates the hard layer and the soft plastic film. The profile of the through hole matches an intended pattern. However, in practice, it is feasible for a patterned soft plastic film to function as a patterned mask. The hard layer is a conventional mask, a piece of glass, or a projector slide. The soft plastic film is resilient and capable of hermetical sealing so as to be tightly attached to the substrate or an organic molecule film layer without undermining the organic light emission characteristics of the organic molecule film layer. In an embodiment, the soft plastic film that demonstrates high performance is made of a silicon-containing polymer. To be specific, the silicon-containing polymer is polydialkylsiloxane, and the alkyl has one to ten carbon atoms. In a specific embodiment, the silicon-containing polymer is polydimethylsiloxane (also known as PDMS for short). PDMS is a polymer. A film made of PDMS is always soft and resilient and can be tightly coupled to the substrate or the organic molecule film layer under atmospheric pressure. However, peeling a PDMS-based film off seldom damages its underlying attachment material. In an embodiment, the patterned mask is fabricated by attaching the soft plastic film to the substrate. In another embodiment, the patterned mask is fabricated by coupling the soft plastic film and the organic molecule film layer together.

The present invention further provides a device for fabricating an organic light emitting diode. The device comprises: a carrier for carrying and spinning a substrate; an organic molecule solution dispensing unit disposed above the carrier so as for the substrate to be disposed between the carrier and the organic molecule solution dispensing unit; a blade disposed above the carrier and beside the organic molecule solution dispensing unit; and a heating unit.

In a specific embodiment, the heating unit is disposed on the carrier such that the substrate is sandwiched between the carrier and the heating unit, and the distance between the heating unit and the substrate allows the blade to cross the substrate. Alternatively, the heating unit is disposed beside the carrier.

In another embodiment, the device of the present invention further comprises a patterned mask for covering the substrate so as for the organic molecule solution dispensing unit to dispense the organic molecule solution and so as for the blade to apply the organic molecule solution to the patterned mask.

With the method of the present invention, it is feasible to fabricate a patterned organic light emitting diode with a multilayer structure, and evenly spread the multilayer structure fabricated by a whole-solution fabrication process. Also, the method of the present invention is applicable to fabrication of a large-area photoelectric component and fit for patterning.

### BRIEF DESCRIPTION OF THE DRAWINGS

The features and advantages of present invention are described in detail hereunder to enable persons skilled in the art to understand and implement the disclosure of the present invention and readily apprehend objectives and advantages of the present invention with references made to the disclosure contained in the specification, the claims, and accompanying drawings, wherein:

FIG. 1 is a schematic view of a device for fabricating an organic light emitting diode according to the present invention;

FIG. 2 is a schematic view of a blade coating process;

FIG. 3 is a schematic view of another device for fabricating an organic light emitting diode according to the present invention;

FIG. 4A (PRIOR ART) is a picture taken of a photoelectric component fabricated by a conventional rod-shaped blade coating;

FIG. 4B through FIG. 4E are pictures taken of photoelectric components fabricated by a method of the present invention;

FIG. 5A through FIG. 5C are schematic views of fabricating a patterned mask according to the present invention;

FIG. 6A through FIG. 6C are schematic views of fabricating a patterned organic molecule film by a patterned mask in an embodiment according to the present invention;

FIG. 7A through FIG. 7C are schematic views of fabricating a patterned organic molecule film by a patterned mask in another embodiment according to the present invention;

FIG. 8A through FIG. 8D are pictures taken of patterned organic light emitting diodes fabricated by a mask, using the method of the present invention;

FIG. 9A is a graph of brightness against voltage, regarding a photoelectric component fabricated by a patterned mask according to the present invention; and

FIG. 9B is a graph of performance against voltage, regarding a photoelectric component fabricated by a patterned mask according to the present invention.

### DETAILED DESCRIPTION OF THE EMBODIMENTS

The present invention is herein illustrated with specific embodiments, so that one skilled in the pertinent art can easily understand other advantages and effects of the present invention from the disclosure of the invention.

In general, an organic light emitting diode is fabricated by disposing on a glass substrate an anode formed by a layer of transparent conductive material made of, for example, tin-doped indium oxide (ITO), disposing on the anode a hole feeding layer, a hole conveying layer, an organic light emitting layer, an electron conveying layer, and an aluminum cathode in sequence, and applying a voltage to between the anode and the cathode, so as for the organic light emitting diode thus fabricated to emit light. The present invention provides a method for fabricating an organic light emitting diode. The method of the present invention attaches great importance to forming the multilayer structure of an organic molecule film, namely a hole feeding layer, a hole conveying layer, an organic light emitting layer, and an electron conveying layer. Fabrication of electrodes is attributable to well-known knowledge in the related field and therefore is not detailed herein.

Referring to FIG. 1, in an embodiment of the method of the present invention, a substrate 15 is disposed on a carrier 11. An organic molecule solution dispensing unit 12 is disposed above the carrier 11, such that the substrate 15 is disposed between the carrier 11 and the organic molecule solution dispensing unit 12. The organic molecule solution dispensing unit 12 dispenses a second organic molecule solution to the substrate 15, before a blade 13 spreads, promptly and evenly, the organic molecule solution on the substrate so as to form a wet film layer. Both the organic molecule solution dispensing unit 12 and the blade 13 are disposed above the carrier 11 and the substrate 15. The blade 13 is disposed beside the organic molecule solution dispensing unit 12. In practice, the positions of the carrier 11 and the substrate 15 can be fixed, respectively, such that both the organic molecule solution dispensing unit 12 and the blade 13 advance in the direction indicated by the arrow A in order to finish applying the wet film layer for a coating purpose. Alternatively, the positions of the organic molecule solution dispensing unit 12 and the blade 13 can be fixed, respectively, such that both the carrier 11 and the substrate 15 advance in the direction indicated by the arrow B. Alternatively, the advance of the organic molecule solution dispensing unit 12 and the blade 13 in the direction indicated by the arrow A and the advance of the carrier 11 and the substrate 15 in the direction indicated by the arrow B take place concurrently so as to apply the organic molecule solution for a coating purpose. The aforesaid movement of the organic molecule solution dispensing unit 12, the blade 13, the carrier 11, and the substrate 15 can be connected to and thus driven by a transmission unit driven by a motor.

A heating unit 14, such as an infrared heater, heats the wet film layer to remove a solvent therefrom and thereby form an organic molecule film. The heating unit 14 is configured to effectuate a target temperature of between 40° C. and 800° C. According to the present invention, the heating unit 14 is connected to and positioned above the carrier 11 (as shown in FIG. 1) or beside the carrier 11, so as to facilitate heating the wet film layer on the substrate 15. The heating unit 14 is positioned in such a way that the substrate 15 is disposed between the carrier 11 and the heating unit 14. The distance between the heating unit 14 and the substrate 15 allows the blade 13 to cross the substrate 15. Furthermore, as shown in FIG. 1, prior to the dispensing step and the coating step, both the organic molecule solution dispensing unit 12 and the blade 13 are disposed beside or outside the substrate 15 to move in the direction opposite to that of the carrier 11 or the substrate 15 and thereby facilitate the implementation of the dispensing step and the coating step.

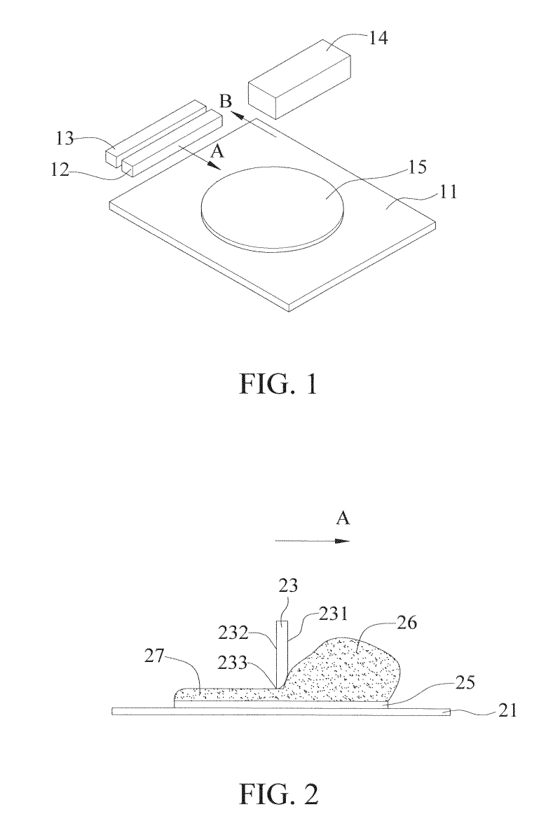

Referring to FIG. 2 for a schematic view of blade coating, a substrate 25 is disposed on a carrier 21, and an organic molecule solution 26 provided by the organic molecule solution dispensing unit is evenly applied to the substrate 25 by a blade 23 for a coating purpose, so as to form a wet film layer 27. The edge of the blade 23 has a planar or linear structure. Preferably, the edge of the blade 23 has a linear structure as shown in FIG. 2. Compared with a conventional planar edge of a blade (which comes into contact with a solution by means of planar contact), a blade with a linear or knife-shaped edge is conducive to reduction in wavy grain of a coated surface and enhancement of uniformity of coating. Furthermore, in a preferred embodiment of the present invention, the blade 23 has a first surface 231 for spreading the organic molecule solution 26 and a second surface 232 opposing the first surface 231. The first and second surfaces 231, 232 converge on a linear or knife-shaped edge 233. In this preferred embodiment, the second surface 232 is a flat surface when proximal to the solution spread, which lacks a specific theoretic basis; however, the flat surface proves to be more effective than a rod-shaped blade with a curved contact surface in eliminating wavy grain in practice. Successful prevention of the wavy grain is attributed to a large included angle between the second surface 232 and the solution (wet film layer) spread and applied, as opposed to a curved contact surface, and/or an approximately right angle between the second surface 232 and the substrate 25 or the solution spread and applied. From an angular point of view, the second surface 232 is a flat surface when proximal to the substrate 25, and the included angle between the second surface 232 and the substrate 25 is a right angle approximately.

In this embodiment, the distance between a blade and a substrate is preferably at least 30 μm so as to eliminate wavy grain and enable a uniform film thickness. In general, a maximum 10 nm difference in film thickness between different points of the film is attainable not only in this embodiment, but also in other embodiments where the distances between the blade and the substrate are 50 μm, 90 μm, and 120 μm, respectively.

Hence, with just a blade, uniformity of a film is attainable by a desirable shape of the blade or an appropriate distance between the blade and a substrate.

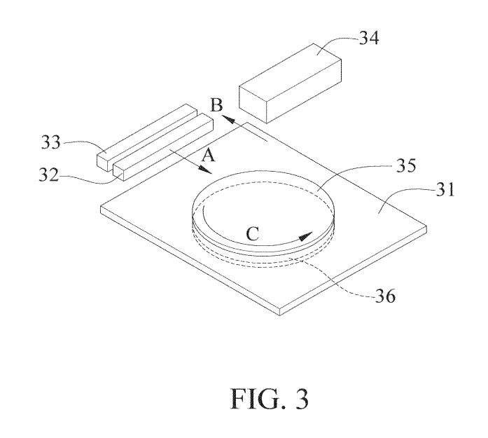

Referring to FIG. 3, in another embodiment, a substrate 35 is disposed on a carrier 31, and an organic molecule solution dispensing unit 32 dispenses the organic molecule solution to the substrate before a blade 33 promptly and evenly spreads the organic molecule solution on the substrate so as to form a wet film layer. As shown in FIG. 3, both the organic molecule solution dispensing unit 32 and the blade 33 are disposed above the carrier 31 and the substrate 35 and move in the direction opposite to that of the carrier 31 and the substrate 35. In practice, the positions of the carrier 31 and the substrate 35 can be fixed, respectively, such that both the organic molecule solution dispensing unit 32 and the blade 33 advance in the direction indicated by the arrow A and thereby effectuate applying the wet film layer for a coating purpose. Alternatively, the positions of the organic molecule solution dispensing unit 32 and the blade 33 can be fixed, respectively, such that the carrier 31 and the substrate 35 advance in the direction indicated by the arrow B. Alternatively, the advance of the organic molecule solution dispensing unit 32 and the blade 33 in the direction indicated by the arrow A and the advance of the carrier 31 and the substrate 35 in the direction indicated by the arrow B take place concurrently so as to effectuate applying the organic molecule solution for a coating purpose.

In this embodiment, the blade 33 is planar, square-shaped, rod-shaped, or knife-shaped. Furthermore, in this specific embodiment, a device for fabricating an organic light emitting diode according to the present invention further comprises a spin coating unit 36 for mounting the carrier 31 on the spin coating unit 36 to thereby form the wet film layer, and spinning the substrate 35 or the carrier 31 in the direction indicated by the arrow C within 10 seconds thereafter. The spinning speed ranges between 100 rpm and 8000 rpm, depending on material-related factors. In so doing, the wet film layer is unlikely to have wavy grain, and cohesion does not occur to the organic molecule solution.

Within 20 seconds after commencement of spinning, a heating unit 34 heats the wet film layer to remove a solvent therefrom and thereby form an organic molecule film. The heating unit 34 is configured to effectuate a target temperature of between 40° C. and 800° C., and preferably between 40° C. and 200° C.

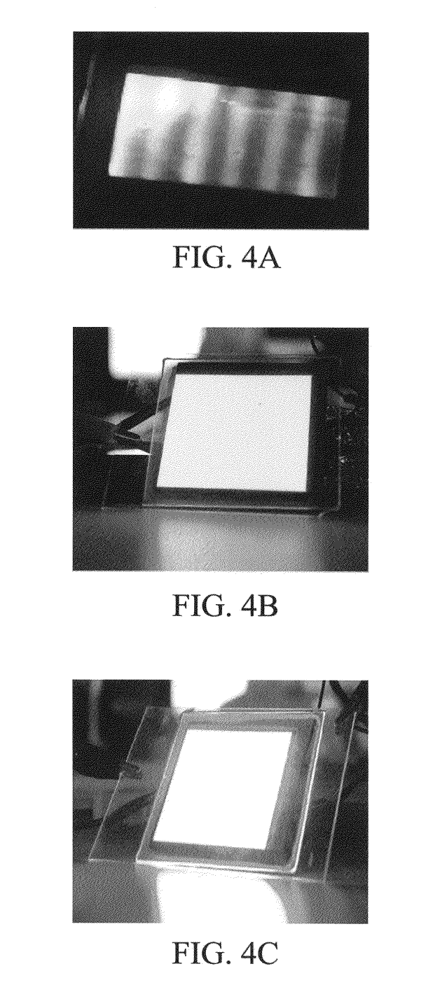

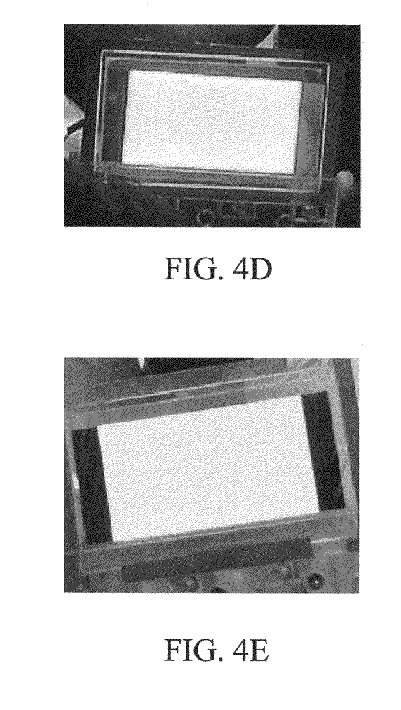

Referring to FIG. 4A, there is shown a picture taken of a photoelectric component fabricated by a conventional rod-shaped blade coating, the organic molecule film layer has wavy grain as a result of uneven coating. Referring to FIG. 4B through FIG. 4E, there are shown pictures taken of photoelectric components fabricated by a method of the present invention, the organic molecule film layer is even and smooth. Also, a uniform layer and components which are not miscible are attainable, using a knife-shaped blade to apply an organic molecule solution for a coating purpose without spinning the substrate.

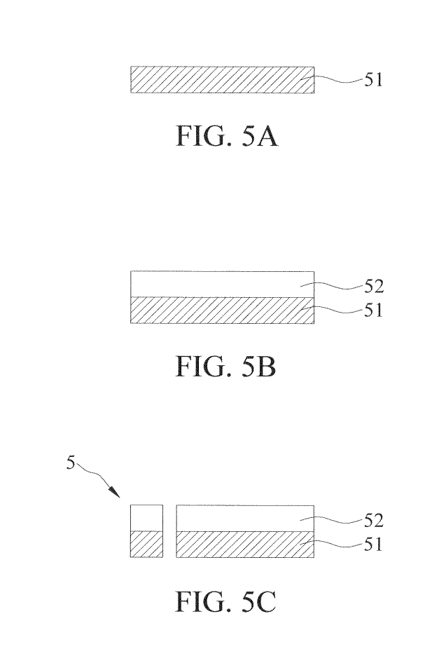

Referring to FIG. 5A through FIG. SC, there are shown schematic views of fabricating a patterned mask according to the present invention. As shown in the drawings, a piece of glass or a projector slide functions as a hard layer 51. The hard layer 51 is coated with a silicon-containing polymer, such as PDMS, before being baked and dried to form a soft plastic film 52. The soft plastic film 52 is patterned by a conventional patterning process to form a patterned mask 5. The patterned mask 5 is configured for use in fabrication of a patterned photoelectric component.

In another specific embodiment, the hard layer, which is a piece of glass or a projector slide, is patterned first, and then the patterned hard layer is coated with a silicon-containing polymer, such as PDMS, to form a soft plastic film before the soft plastic film is patterned to form a patterned mask.

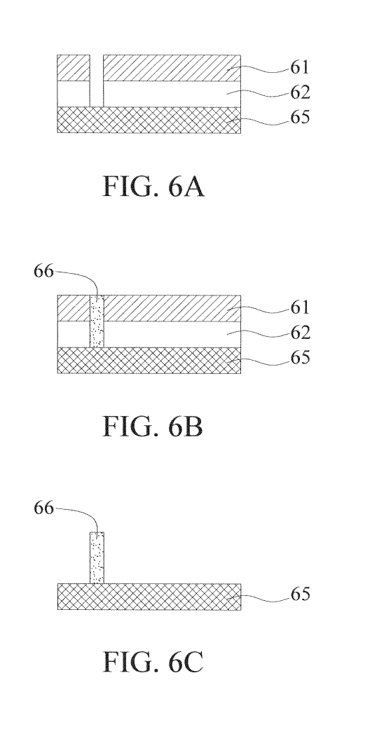

Please refer to FIG. 6A for fabrication of a film. As shown in the drawing, a soft plastic film 62 formed from PDMS is attached to a substrate 65 and configured to be sandwiched between a hard layer 61 and the substrate 65. The soft plastic film 62 and the substrate 65 adhere to each other tightly due to atmospheric pressure. Peeling the PDMS-based soft plastic film 62 off the substrate 65 leaves the surface of the substrate 65 intact. Referring to FIG. 6B through FIG. 6C, a patterned organic molecule film 66 is attained by forming a wet film layer composed of an organic solution, heating the wet film layer to remove a solvent therefrom, and removing a mask therefrom.

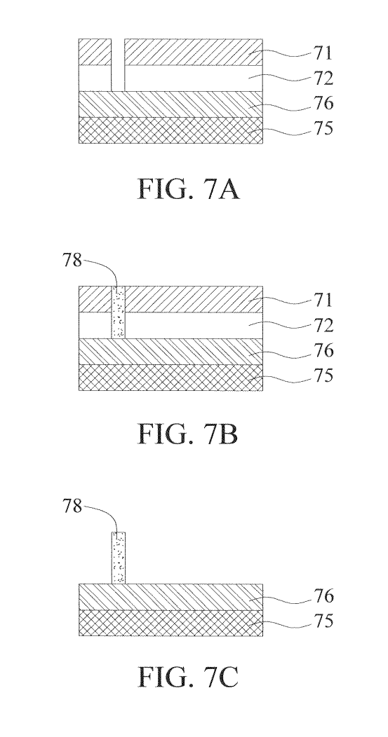

In another embodiment illustrated with FIG. 7A, a first organic molecule film 76 is formed on a substrate 75, and then a soft plastic film 72 is attached to the first organic molecule film 76 and configured to be sandwiched between a hard layer 71 and the first organic molecule film 76. The soft plastic film 72 and the first organic molecule film 76 adhere to each other tightly due to atmospheric pressure. Peeling the PDMS-based soft plastic film 72 off the first organic molecule film 76 leaves the surface of the first organic molecule film 76 intact. Referring to FIG. 7B through FIG. 7C, a wet film layer of the second organic molecule solution is formed and heated to remove the solvent therefrom, and then removed a patterned mask therefrom to obtain a patterned second organic molecule film 78.

With the method of the present invention and the patterned second organic molecule film fabricated, a PFO film made of a blue light emitting material is formed on a transparent ITO substrate, and then a patterned PDMS mask is attached to the PFO film. Afterward, a coating and spinning process is performed on super yellow, a lithographic material, by a blade so as to form the patterned second organic molecule film layer 40 nm thick before removing a patterned PDMS mask therefrom. Lastly, a CsF layer and an aluminum layer are formed in sequence by evaporation to function as a cathode, and in consequence a patterned organic light emitting diode is obtained.

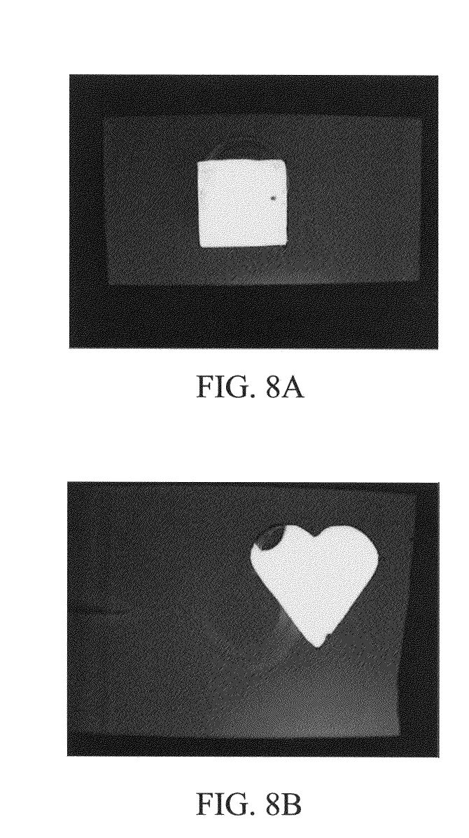

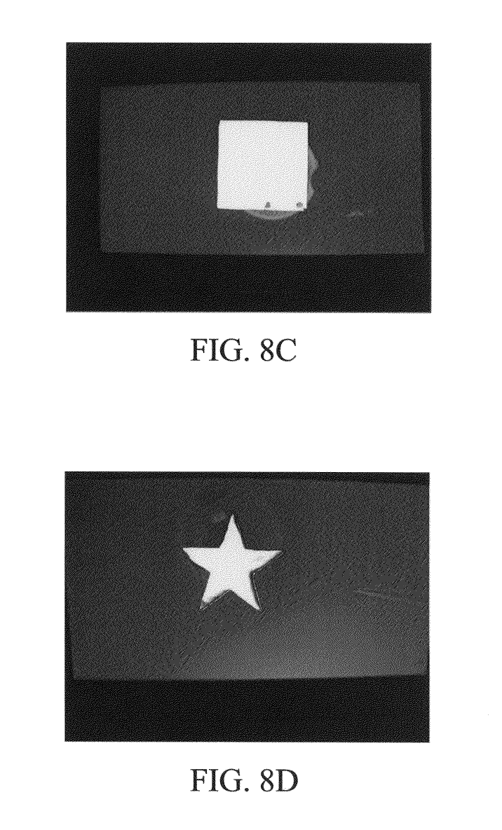

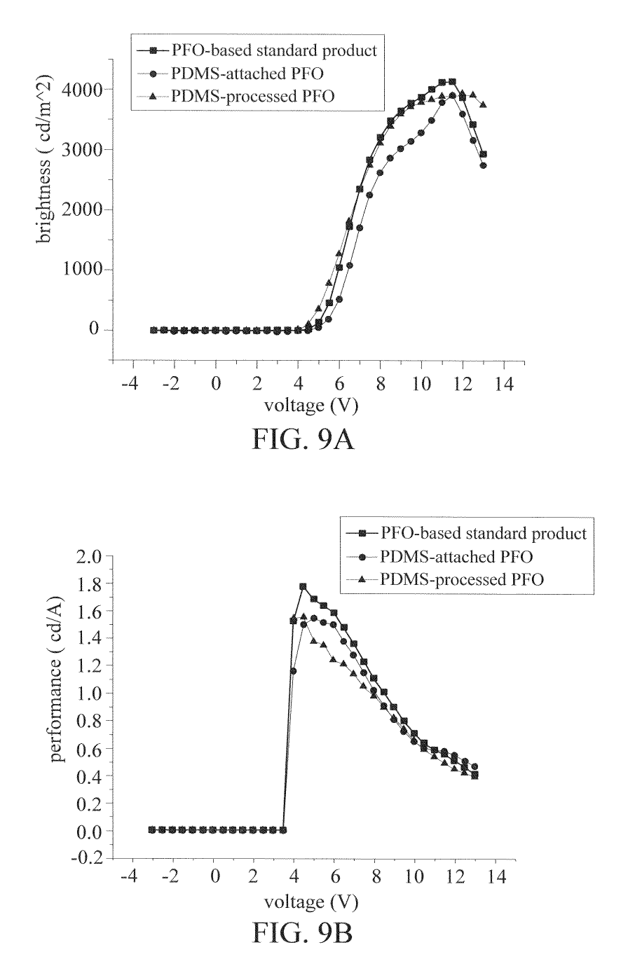

Referring to FIG. 8A through FIG. 8D, there are shown pictures taken of patterned organic light emitting diodes fabricated by a PDMS mask, using the method of the present invention. FIG. 9A is a graph of brightness against voltage, regarding a photoelectric component fabricated by a patterned mask according to the present invention. FIG. 9B is a graph of performance against voltage, regarding a photoelectric component fabricated by a patterned mask according to the present invention. As shown in FIG. 9A and FIG. 9B, an ordinary PFO-based standard product, a PDMS-attached PFO film, and a PDMS-processed PFO film are represented by three curves, respectively, and the brightness and performance of the PDMS-attached PFO film and the PDMS-processed PFO film approximate to that of the PFO-based standard product.

Referring to FIG. 8A through FIG. 8D, FIG. 9A, and FIG. 9B, the pattern of a photoelectric component fabricated by blade coating and a PDMS mask is variable and thus versatile. Unlike a photoelectric component fabricated in the absence of a mask, a photoelectric component fabricated by a PDMS mask demonstrates unabated brightness and performance.

The aforesaid embodiments are intended to illustrate the composition and a fabrication method of the present invention but are not intended to limit the present invention. It should be understood by those in the art that many modifications and variations can be made according to the spirit and principle in the disclosure of the present invention and still fall within the scope of the invention as set forth in the appended claims.

What is claimed is:

1. A method for fabricating an organic light emitting diode, comprising steps of:
(a) providing a substrate;
(b) dispensing to the substrate a second organic molecule solution resulting from dissolving a second organic molecule in a solvent;
(c) applying the second organic molecule solution to a surface of the substrate so as to form a wet film layer; and
(d) heating the wet film layer to remove the solvent therefrom and thereby form a second organic molecule film.

2. The method of claim 1, further comprising spinning the substrate after step(c).

3. The method of claim 1, wherein the wet film layer is applied by a blade, for a coating purpose.

4. The method of claim 2, wherein the spinning of the substrate is carried out at a speed of 100 rpm to 8000 rpm.

5. The method of claim 4, wherein the spinning of the substrate is performed within 10 seconds after step(c).

6. The method of claim 4, wherein the heating of the wet film layer is performed within 20 seconds after the spinning of the substrate begins.

7. The method of claim 1, wherein the wet film layer is heated at a temperature ranging from 40° C. to 800° C.

8. The method of claim 1, wherein the substrate is provided with a first organic molecule film formed thereon, so as for the second organic molecule solution to be coated on the first organic molecule film, to thereby form the second organic molecule film.

9. The method of claim 8, further comprising covering the substrate with a patterned mask before step (b) or patterning the first organic molecule film via a patterned mask before coating the second organic molecule solution thereon, so as for the second organic molecule film to be patterned.

10. The method of claim 9, wherein the patterned mask comprises a patterned soft plastic film.

11. The method of claim 10, wherein the patterned soft plastic film is made of silicon-containing polymer.

12. The method of claim 11, wherein the silicon-containing polymer is polydialkylsiloxane, in which the alkyl has one to ten carbon atoms.

13. The method of claim 8, wherein the coating of the second organic molecule solution on the first organic molecule film is performed by a blade with a planar or linear edge.

14. The method of claim 13, further comprising spinning the substrate at 100 rpm to 8000 rpm within 10 seconds after step(c).

15. The method of claim 14, wherein step(d) is performed at a temperature ranging from 40° C. to 800° C. within 20 seconds after the spinning the substrate begins.

16. The method of claim 13, wherein a distance between the blade and the substrate is at least 30 μm.

17. The method of claim 13, wherein the blade has a first surface for spreading the second organic molecule solution and a second surface opposing the first surface, and the second surface is a flat surface when proximal to the second organic molecule solution.

18. The method of claim 13, wherein the blade has a first surface for spreading the second organic molecule solution and a second surface opposing the first surface, and an included angle between the second surface and the wet film layer is a right angle.

19. A device for fabricating an organic light emitting diode, comprising:
a carrier for carrying and spinning a substrate;
an organic molecule solution dispensing unit disposed above the carrier so as for the substrate to be disposed between the carrier and the organic molecule solution dispensing unit;
a blade disposed above the carrier and beside the organic molecule solution dispensing unit; and
a heating unit.

20. The device of claim 19, wherein the heating unit is disposed above the carrier so as for the substrate to be disposed between the carrier and the heating unit, and a distance between the heating unit and the substrate allows the blade to cross the substrate.

21. The device of claim 19, wherein the heating unit is disposed beside the carrier.

22. The device of claim 19, wherein the blade has a liner or planar edge.

23. The device of claim 19, wherein the heating unit is an infrared heater or a hot-air heater.

24. The device of claim 19, further comprising a spin coating unit for mounting the carrier thereon and thereby spinning the carrier.

25. The device of claim 19, further comprising patterned mask for covering the substrate so as for the organic molecule solution dispensing unit to dispense an organic molecule solution and so as for the blade to spread the organic molecule solution on the patterned mask.

26. The device of claim 25, wherein the patterned mask comprises a patterned soft plastic film.

27. The device of claim 26, wherein the patterned soft plastic film is made of a silicon-containing polymer.

28. The device of claim 27, wherein the silicon-containing polymer is polydialkylsiloxane, in which the alkyl has one to ten carbon atoms.

29. The device of claim 22, wherein the blade has a first surface for spreading the organic molecule solution and a second surface opposing the first surface, and the second surface is a flat surface when proximal to the substrate.

30. The device of claim 22, wherein the blade has a first surface for spreading the organic molecule solution and a second surface opposing the first surface, and an included angle between the second surface and the substrate is a right angle.
